(19) United States
(12) Patent Application Publication
(10) Pub. No.: US 2026/0102652 A1
(43) Pub. Date: Apr. 16, 2026

(54) TREADMILL WITH LIGHT STRIP

(71) Applicant: Shenzhen Yile Dynamic Technology Co., LTD, Shenzhen (CN)

(72) Inventors: Wenwen YE, Shenzhen (CN); Jinsong FAN, Shenzhen (CN)

(73) Assignee: Shenzhen Yile Dynamic Technology Co., LTD, Shenzhen (CN)

(21) Appl. No.: 18/928,377

(22) Filed: Oct. 28, 2024

(30) Foreign Application Priority Data
Oct. 10, 2024 (CN) 202422460568.3

(51) Int. Cl. A63B 22/02; A63B 24/00; F21S 4/28; F21V 23/00; F21Y 103/10; F21Y 113/00; F21Y 115/10

(52) U.S. Cl. CPC A63B 22/02; A63B 24/0087; F21S 4/28; F21V 23/005; A63B 2225/74; F21Y 2103/10; F21Y 2113/00; F21Y 2115/10

(57) ABSTRACT

A treadmill with a light strip includes a frame and a treadmill. At least one side of the running belt along its movement direction is provided with a side rail. A light strip is installed on one side of the side rail facing the frame, and the light strip is electrically connected to a controller. The light strip includes a plurality of lamp units, and each lamp unit includes a driving chip and at least one lamp bead. The controller is electrically connected to the plurality of lamp units and controls a lighting state of the plurality of lamp units to allow the light strip to optionally present a preset lighting effect.

### CROSS-REFERENCE TO RELATED APPLICATIONS

This application claims priority benefits to Chinese Patent Application No. 2024224605683, filed on Oct. 10, 2024, the contents of which are incorporated herein by reference in its entirety.

### TECHNICAL FIELD

The present disclosure relates to the technical field of treadmills, and in particular, to a treadmill with a light strip.

### BACKGROUND

A treadmill is a common fitness equipment that occupies a small area, making it widely used.

### SUMMARY

A treadmill with a light strip, including a frame and a running belt, a first end of the frame provided with a first roller, a second end of the frame provided with a second roller, the first roller and the second roller arranged opposite to each other, and the running belt surrounding the first roller and the second roller; at least one side of the running belt along its movement direction provided with a side rail, one side of the side rail facing the frame arranged with a light strip, and the light strip electrically connected to a controller; the light strip includes a plurality of lamp units, each lamp unit includes a driving chip and at least one lamp bead, and the driving chip electrically connected to the at least one lamp bead; and the controller electrically connected to the plurality of lamp units and controlling a lighting state of the plurality of lamp units to allow the light strip to present a preset lighting effect.

### BRIEF DESCRIPTION OF DRAWINGS

The description and drawings that constitute a part of the present disclosure are provided for a further understanding of the present disclosure. The illustrative embodiments and their descriptions are provided for explanation but do not constitute improper limitations on the present disclosure.

FIG. 1 is a schematic structural view of the overall structure of a treadmill according to an embodiment of the present disclosure.

FIG. 2 is a partial enlarged schematic structural view of part A of FIG. 1, and no light strip is installed in the side groove.

FIG. 3 is a partial enlarged view of area A in FIG. 1, with a light strip installed in a side groove.

FIG. 4 is a schematic structural view from another perspective of FIG. 1.

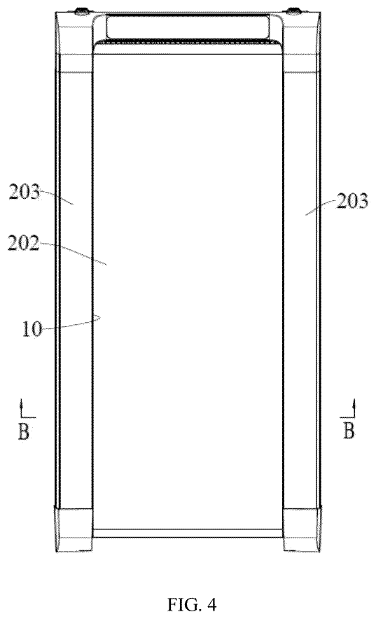

FIG. 5 is a cross-sectional view in the BB direction of FIG. 4.

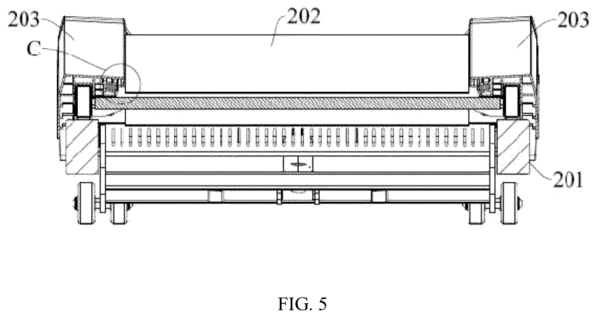

FIG. 6 is a detailed enlarged view of area C in FIG. 5, with a side light slot not having a light strip installed.

FIG. 7 is a partial enlarged schematic structural view of C in FIG. 5, and a light strip is installed in the side groove.

FIG. 8 is a schematic structural view of a light strip according to an embodiment of the present disclosure.

FIG. 9 is a schematic structural view of another treadmill according to an embodiment of the present disclosure.

FIG. 10 is a schematic structural view of a second end cover according to an embodiment of the present disclosure.

FIG. 11 is an exploded view of a second end cover according to an embodiment of the present disclosure.

FIG. 12 is a cross-sectional view in the DD direction of FIG. 10.

FIG. 13 is a circuit diagram of a light strip according to an embodiment of the present disclosure.

FIG. 14 is a circuit diagram of another light strip according to an embodiment of the present disclosure.

### DETAILED DESCRIPTION OF THE EMBODIMENTS

The present disclosure may be described in detail below with reference to the accompanying drawings and in conjunction with various embodiments. Each example is provided to explain but not limit the present disclosure. In fact, it may be clear to those of ordinary skill that modifications and variations may be made without departing from the scope or spirit of the present disclosure. For example, a feature shown or described as part of one embodiment may be used according to another embodiment to produce yet another embodiment. Therefore, it is intended that the present disclosure includes such modifications and variations within the scope of the appended claims and their equivalents.

In the embodiments of the present disclosure, the terms “longitudinal”, “lateral”, “upper”, “lower”, “front”, “back”, “left”, “right”, “vertical”, “horizontal”, “top”, “bottom” and the like indicate the orientational or positional relationship based on the orientational or positional relationship illustrated in the drawings, which is only for the convenience of describing and does not require the present disclosure to be constructed and operated in a specific orientation, and therefore cannot be understood as limiting the present disclosure. The terms “connected”, “connecting” and “arranged” used in the present disclosure should be understood in a broad sense. For example, it may be a fixed connection or a detachable connection; it may be directly connected or indirectly connected through an intermediate component; it may also be a wired electrical connection, a radio connection, or a wireless signal connection. For those of ordinary skill in the art, the specific meanings of the above terms may be understood according to the specific circumstances.

One or more examples of the present disclosure are illustrated in the attached drawings. Numbers and letter signs are used in the detailed description to refer to features in the drawings. Similar signs in the drawings and descriptions have been configured to refer to similar parts of the present disclosure. As used herein, the terms “first”, “second” and “third” are used interchangeably to distinguish one component from another and are not intended to indicate the position or importance of individual components.

The light strip in the present disclosure can display lighting effects that match the treadmill's operational state, enhancing interaction between the treadmill and the user.

According to an embodiment of the present disclosure, a light strip 10 for a treadmill 20 is provided, and the light strip 10 is linked with the treadmill 20 through a controller 30. The lighting effect of the light strip 10 is adjusted according to the state of the treadmill 20.

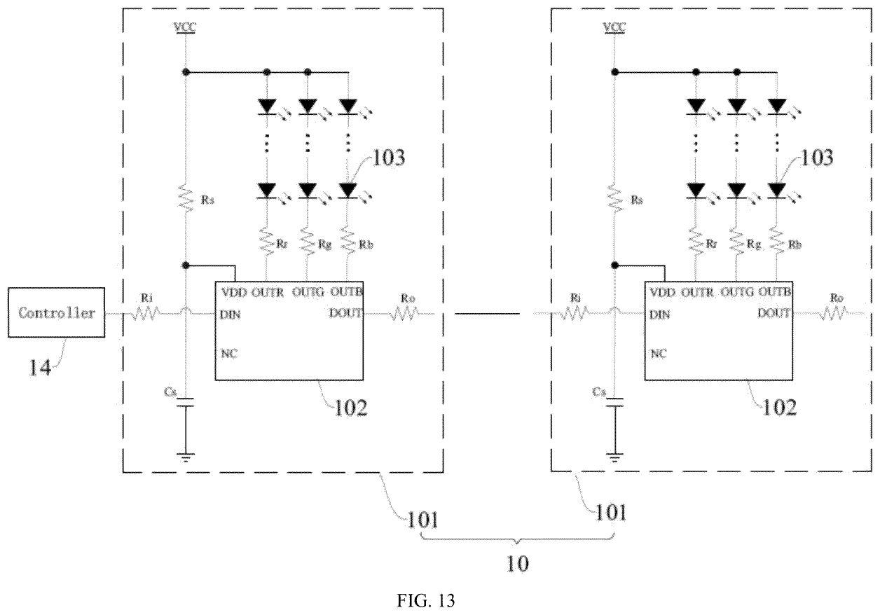

As illustrated in FIG. 13, the light strip 10 includes a plurality of lamp units 101, the lamp unit 101 includes a driving chip 102 and at least one lamp bead 103, and the driving chip 102 is electrically connected to the at least one lamp bead 103. The controller 30 is electrically connected to the light strip 10, and controls the plurality of lamp units 101 to achieve dynamic lighting effects, such as flowing, breathing, gradual change, and flashing, etc.

In general, the number of the lamp beads 103 electrically connected to the driving chip 102 affects the lighting effect of the light strip 10. For example, the driving chip 102 can drive one lamp bead 103, three lamp beads 103, and six lamp beads 103. The fewer lamp beads 103 connected to the driving chip 102, the more delicate the dynamic lighting effect of the light strip 10 is.

The plurality of lamp units 101 are distributed linearly and encapsulated in a flexible material to form a strip structure, providing good waterproof and tensile properties. The flexible material includes at least one light-transmitting material, such as plastic and silicone. The light-transmitting material is configured to package at least a light-emitting side of the light strip 10, and the light from the lamp beads 103 can be emitted through the light-transmitting packaging material. A backlight side of the light strip 10 has no restrictions on the light transmittance of the flexible material.

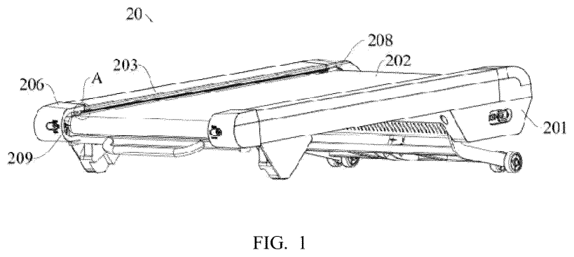

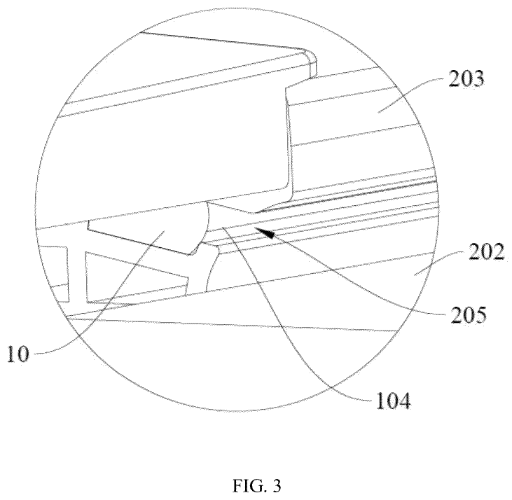

As illustrated in FIG. 1 and FIG. 3, a treadmill 20 includes a frame 201 and a running belt 202, a first end of the frame 201 is provided with a first roller 208, a second end of the frame 201 is provided with a second roller 209, and the first roller 208 and the second roller 209 are arranged opposite to each other. The running belt 202 surrounds the first roller 208 and the second roller 209. Both sides of the running belt 202 are provided with a side rail 203, and the side rails 203 are fixedly installed above the frame 201. The two side rails 203 are both equipped with the above-mentioned light strip 10, and the light strip 10 is arranged on a side of the side rail 203 facing the frame 201. The light strip 10 is hidden under the side rail 203, which plays a protective role to prevent the light strip from being accidentally bumped and damaged. Compared with exposing the light strip on an outside of the treadmill 20, the design in a concealed manner is safer. In addition, there is a gap between the side rail 203 and a side of the running belt 202, and the light from the light strip 10 can be transmitted through the gap and illuminated on the running belt 202, making the lighting and shadowing effect of the treadmill 20 softer.

The running state of the treadmill 20 corresponds to the movement state of the user. When the user is jogging or running, the treadmill 20 synchronizes with the user at different speeds. Therefore, the movement state of the user can be indirectly obtained through the movement state of the treadmill 20. The light strip 10 can adjust its lighting effect according to the running state, thereby keeping in sync with the user.

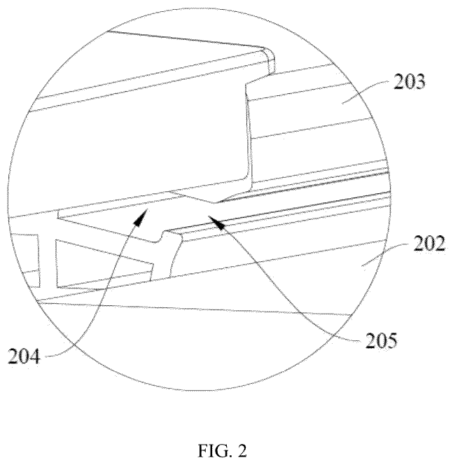

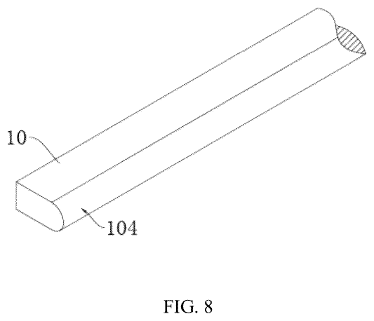

As illustrated in FIG. 2, FIG. 3 and FIG. 8, in some embodiments, one side of the side rail 203 facing the frame 201 is defined with a side groove 204, and the side groove 204 is provided along the moving direction of the running belt 202. The side groove 204 is defined with an opening 205, and the opening 205 faces the running belt 202. The light strip 10 is provided in the side groove 204, and a light-emitting surface 104 of the light strip 10 faces the opening 205.

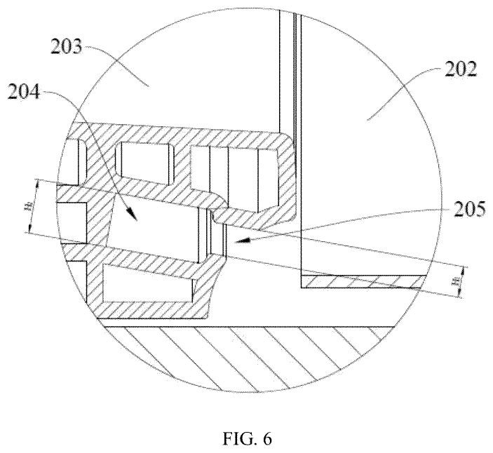

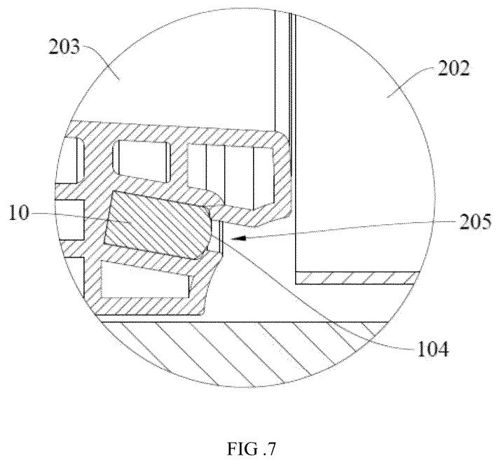

As illustrated in FIG. 6 and FIG. 7, in some embodiments, in a longitudinal direction of the side groove 204, a width H₁ of a cross section of the opening 205 is smaller than a width H₂ between inner walls, adjacent to the opening 205, of two sides of the side groove 204, enabling the light from the light strip 10 to be emitted out of the opening 205 while the light strip 10 to be restricted in the side groove 204.

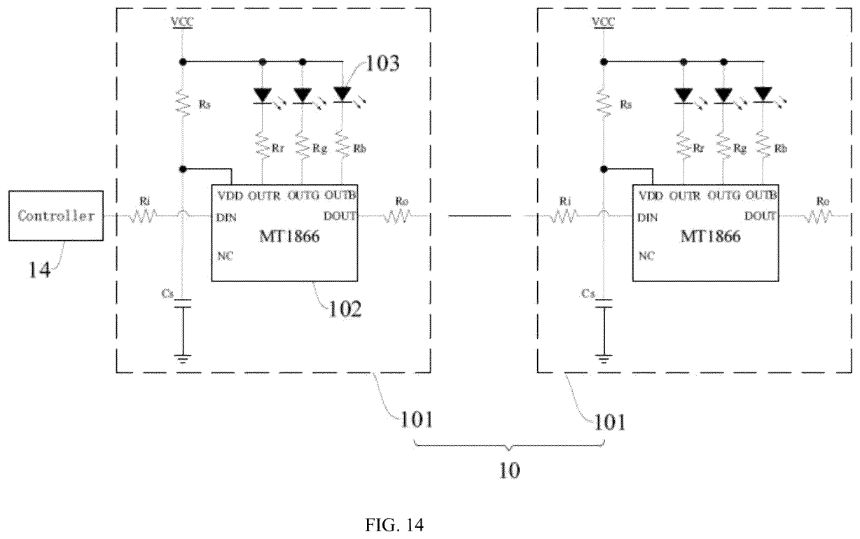

As illustrated in FIG. 14, in some embodiments, the driving chip 102 of the light strip 10 is selected from the group consisting of TM1903 and TM1866. An input voltage is DV12V, a rated power of the lamp beads 103 is 0.2 W, and each driving chip 102 controls three lamp beads 103. The spacing of the lamp beads 103 may affect the overall lighting effect of the light strip 10. When exposed, the smaller the spacing of the lamp beads 103, the smaller the dark area between the lamp beads 103, and the overall lighting effect of the light strip 10 is linear. On the contrary, a larger spacing of the lamp beads 103 making the overall lighting effect of the light strip 10 to be a dotted pattern. The light strip 10 in the present disclosure is set up in a concealed manner, allowing for a larger spacing between the lamp beads 103 in the light strip 10. As a result, the light emitted from the side of the running belt 202 of the light strip 10 is not significantly affected. For example, the spacing of the lamp beads 103 is set to 11.9 mm±0.5 mm. The wider interval between the lamp beads 103 can reduce the number of lamp beads 103 and the cost of the light strip 10. In addition, the power consumption of the light strip 10 will also be reduced, making it more energy efficient.

The light strip of the present disclosure can optionally be configured into multiple segments, allowing for the adjustment of the distance between the lamp beads in each segment based on different positions. Where feasible, the distance between the lamp beads in the light strip can be appropriately increased to reduce the cost and the power consumption of the light strip, achieving energy-saving and emission reduction goals.

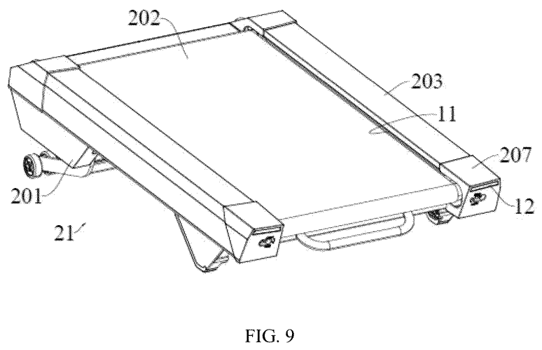

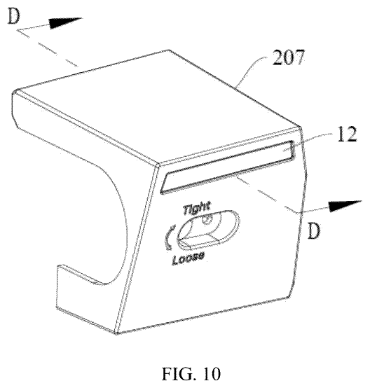

As illustrated in FIG. 9 and FIG. 10, in some embodiments, the light strip 10 includes a side light strip 11 and an end light strip 12, the side light strip 11 and the end light strip 12 are both provided with a plurality of lamp units 101, and the side light strip 11 is electrically connected to the end light strip 12. The side light strips 11 are installed in the side grooves 204 of both sides of the running belt 202, and the end light strip 12 is installed on the second end cover 207. The treadmill 21 shows different atmospheres because of the multiple segments of the light strip 10 and adjusts the lighting effect of the light strip 10 according to the running state of the treadmill 21. Since the side light strip 11 is designed in a concealed manner, the spacing between the lamp beads 103 on the side light strip 11 can be slightly larger, and its width can be set to 11.9 mm±0.5 mm. However, the end light strip 12 can be optionally exposed. Therefore, to make the end light strip 12 have a better lighting effect, the spacing between the lamp beads 103 of the end light strip 12 can be set slightly smaller, for example, its width is set to 10.4 mm±0.5 mm.

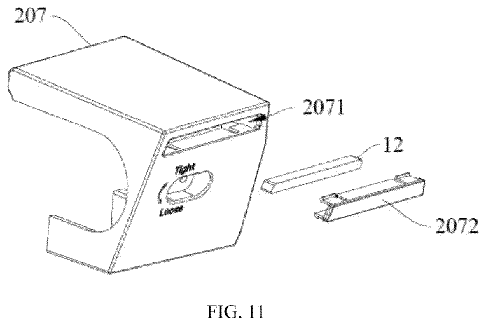

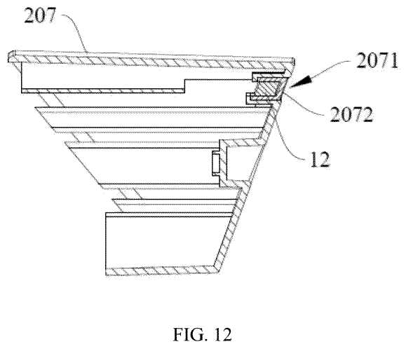

As illustrated in FIG. 11 and FIG. 12, in some embodiments, one end of the second end cover 207 is defined with an end groove 2071. The end light strip 12 is installed in the end groove 2071 to prevent the end light strip 12 from protruding out too much and getting damaged. The end light strip 12 is arranged in the groove to enhance its safety. The end groove 2071 is provided with an opening 205, and the opening 205 is arranged toward an outside of the treadmill 21, and the light-emitting surface 104 of the end light strip 12 faces the opening 205 of the end groove 2071.

In some embodiments, a lamp cover 2072 is installed in the end groove 2071, and the end light strip 12 is restricted in the end groove 2071 by the lamp cover 2072. As a result, the lamp cover 2072 provides further protection for the end light strip 12. In some embodiments, the lamp cover 2072 is snapped into the inner wall of the end groove 2071.

As illustrated in FIG. 1, in some embodiments, the treadmill 20 is provided with a control circuit and a motor, and the motor is configured to drive the running belt 202 to rotate around the first roller 208 and the second roller 209. The control circuit is electrically connected to the motor, and the controller 30 is arranged on the control circuit.

In some embodiments, the controller includes an MCU (Microcontroller Unit), and different models of MCUs can be selected based on different requirements. For example, the MCU of the HC89F0541 model can be selected. The motor and the light strip are both electrically connected to the MCU, and a control program is preset in the MCU. The MCU calculates the speed of the running belt based on information such as the motor's back electromotive force and current. The MCU's preset control program preset controls the lighting effect of the light strip according to the obtained speed of the running belt. The lighting effects include flowing, breathing, gradient, flashing and others.

In some embodiments, the treadmill is equipped with a sensor for monitoring the speed of the running belt, the sensor is electrically connected to the controller, and the controller can control the lighting effect of the light strip through the speed of the running belt obtained by the sensor. The sensor includes a contact sensor and a non-contact sensor, for example, a Hall effect sensor can be used.

In some embodiments, the preset control program includes a plurality of lighting modes of the light strip, the treadmill is provided with a display screen and an electronic button, and the display screen and the electronic button are both electrically connected to the controller. The user can select a preset lighting mode through the electronic button or set a personalized lighting effect according to personal preference. The display screen can be combined with the electronic button to form a touch screen.

In some embodiments, the control circuit includes a wireless communication circuit, and the wireless communication circuit includes at least one communication circuit of WIFI and Bluetooth. The control circuit can be optionally connected to the mobile phone through wireless communication circuit and set the lighting effect of the light strip through an APP (application) installed in a mobile phone.

The above-mentioned mobile phone can be replaced by other electronic devices. The electronic device is installed with an APP, which can realize the function of the APP in the mobile phone.

In the embodiments of the present disclosure, the lighting mode of the light strip can be selected or set through the electronic button on the treadmill or a mobile phone, so as to further optimize the interaction between the treadmill and the user.

The above description is only some embodiments of the present disclosure and is not intended to limit the present disclosure. For those of ordinary skill in the art, the present disclosure may have various modifications and variations. Any modification, equivalent replacement, improvement, etc. made within the spirit and principle of the present disclosure shall be included in the protection scope of the present disclosure.

What is claimed is:

1. A treadmill with a light strip, comprising a frame and a running belt, wherein a first end of the frame is provided with a first roller, a second end of the frame is provided with a second roller, the first roller and the second roller are arranged opposite to each other, and the running belt surrounds the first roller and the second roller;
at least one side of the running belt along a movement direction thereof is provided with a side rail, one side of the side rail facing the frame is arranged with a light strip, and the light strip is electrically connected to a controller;
the light strip comprises a plurality of lamp units, each lamp unit comprises a driving chip and at least one lamp bead, and the driving chip is electrically connected to the at least one lamp bead; and
the controller is electrically connected to the plurality of lamp units and controls a lighting state of the plurality of lamp units to allow the light strip to present a preset lighting effect.

2. The treadmill according to claim 1,
wherein the plurality of lamp units is linearly distributed, a wrapping layer is provided on an outer side of the light strip, and the wrapping layer on a light-emitting side of the light strip is capable of transmitting a light emitted by the light strip.

3. The treadmill according to claim 1,
wherein one side of the side rail facing the frame is defined with a side groove, the side groove is arranged along the movement direction of the running belt, the side groove is provided with an opening, the opening faces the running belt, and the light strip is arranged in the side groove.

4. The treadmill according to claim 3,
wherein, along a longitudinal direction of the side groove, a width of a cross section of the opening is smaller than that between inner walls, adjacent to the opening, of the side groove.

5. The treadmill according to claim 1,
wherein at least one end of the side rail is provided with an end cover;
the light strip comprises at least two light strip segments electrically connected to each other; and
one or more of the at least two light strip segments is installed on one side, facing the frame, of the side rail; one or more of the at least two light strip segments is installed on the end cover.

6. The treadmill according to claim 5,
wherein a spacing between two adjacent lamp beads in one light strip segment is equal, and the spacing between two adjacent lamp beads in different light strip segments is equal or different.

7. The treadmill according to claim 5,
wherein one end of the end cover is defined with an end groove, and one or more of the at least two light strip segments is installed in the end groove.

8. The treadmill according to claim 7,
wherein a lamp cover is installed on the end groove, and one or more of the at least two light strip segments is restricted in the end groove by the lamp cover.

9. The treadmill according to claim 1,
wherein the controller obtains a movement speed of the running belt and controls the light strip to present the preset lighting effect matching the movement speed of the running belt.

10. The treadmill according to claim 9,
wherein the treadmill is provided with an electronic button, the electronic button is electrically connected to the controller, and the lighting effect of the light strip is selected or set through the electronic button.

11. The treadmill according to claim 9,
wherein the controller is electrically connected to a communication circuit, the controller is capable of being electrically connected to an electronic device through the communication circuit, and the electronic device is configured to select or set the lighting effect of the light strip through an application installed in the electronic device.

12. A treadmill with a light strip, comprising a frame and a running belt;
wherein at least one side of the running belt along a movement direction thereof is provided with a side rail, one side of the side rail facing the frame is arranged with a light strip, and the light strip is electrically connected to a controller;
the light strip comprises a plurality of lamp units, each lamp unit comprises a driving chip and at least one lamp bead, the driving chip is electrically connected to the at least one lamp bead, the plurality of lamp units is linearly distributed, a wrapping layer is provided on an outer side of the light strip, and the wrapping layer on a light-emitting side of the light strip is capable of transmitting a light emitted by the light strip; and
the controller is electrically connected to the plurality of lamp units and controls a lighting state of the plurality of lamp units to allow the light strip to present a preset lighting effect.

13. A treadmill with a light strip, comprising a frame and a running belt;
wherein at least one side of the running belt along a movement direction thereof is provided with a side rail, one side of the side rail facing the frame is arranged with a light strip, and the light strip is electrically connected to a controller;
the light strip comprises a plurality of lamp units, each lamp unit comprises a driving chip and at least one lamp bead, the driving chip is electrically connected to the at least one lamp bead;
the controller is electrically connected to the plurality of lamp units and controls a lighting state of the plurality of lamp units to allow the light strip to present a preset lighting effect; and
one side of the side rail facing the frame is defined with a side groove, the side groove is arranged along the movement direction of the running belt, the side groove is provided with an opening, the opening faces the running belt, and the light strip is arranged in the side groove.
